(19) United States
(12) Patent Application Publication
(10) Pub. No.: US 2025/0253733 A1
(43) Pub. Date: Aug. 7, 2025

(54) MOTOR AND COMPRESSOR

(71) Applicant: AICHI ELECTRIC CO., LTD., KASUGAI-SHI (JP)

(72) Inventors: Masahiro HASEGAWA, Kasugai-shi (JP); Takashi HORI, Kasugai-shi (JP)

(21) Appl. No.: 19/041,030

(22) Filed: Jan. 30, 2025

(30) Foreign Application Priority Data
Feb. 6, 2024 (JP) 2024-016607
Feb. 6, 2024 (JP) 2024-016608

(51) Int. Cl. H02K 3/52; F25B 31/02

(52) U.S. Cl. CPC H02K 3/522; F25B 31/026; H02K 2203/12

(57) ABSTRACT

In an electric motor, an electrical insulation body (70) includes a first outer wall part (72), a first drum part (74), and a first inner wall part (76). The first drum part has first and second side surfaces (741, 742). The electrical insulation body further includes a projection (744) formed at a connection part (743) between the first drum part and the first outer wall part and having an inclined wall surface (744S) that connects an inner peripheral surface (720) of the first outer wall part to the first side surface. The electrical insulation body is mounted on a stator core (80) that includes a cutout (86) having a recessed shape formed in a tooth second side surface (842) and/or a yoke inner peripheral surface (820), and/or a tooth projection (88) formed at a connection part (863) between a tooth first side surface (841) and the yoke inner peripheral surface.

### CROSS-REFERENCE TO RELATED APPLICATIONS

The present application claims priority to Japanese patent application Nos. 2024-016607 and 2024-016608, both filed on Feb. 6, 2024. The contents of the foregoing applications are hereby fully incorporated herein by reference.

### TECHNICAL FIELD

The present disclosure relates to a motor and to a compressor.

### BACKGROUND ART

A known concentrated winding motor comprises a concentrated winding stator including an electrical insulation body that insulates a stator core and stator windings (coils) wound around teeth of the stator core. The stator includes a yoke extending in a circumferential direction, teeth extending radially inward from the yoke, and slots respectively defined between the adjacent ones of the teeth. Each of the teeth has a tooth base part that extends radially inward from the yoke and a tooth tip part that is formed on a tip end side of the tooth base part and extends in the circumferential direction. For example, in Japanese Unexamined Patent Application Publication No. 2002-272045, a stator is disclosed in which an inclined surface is formed at a first side surface in an axial direction of the tooth base part. As a result, it is possible to smoothly wind the stator windings to an outer side in the radial direction along the inclined surface formed on the tooth base part.

### SUMMARY

However, in the above-described known technology, the stator windings may be wound such that lead wires (or portions of a single lead wire) thereof cross each other, whereby the space factor of the stator winding inside the slot may be reduced. Further, in recent years, the stator core and the electrical insulation body are sometimes integrally formed by insert molding. Thus, a technique is desired that improves the space factor of the stator winding inside the slot, while avoiding manufacturing defects during the insert molding.

The present disclosure can be realized as the following aspects.

(1) According to one aspect of the present disclosure, a motor comprises a stator and a rotor. The stator has a stator core, an electrical insulation body, and stator windings (coils). The stator core has a cylindrical shape extending in an axial direction. The stator core has a yoke extending in a circumferential direction, and teeth extending radially inward from the yoke. Each of the teeth has a tooth base part extending radially inward from the yoke, and a tooth tip part that is continuous with a radially inward tip end of the tooth base part. The tooth base part has a tooth first side surface on a first side in the circumferential direction and a tooth second side surface on a second side in the circumferential direction. The electrical insulation body has a first outer wall part arranged (disposed) on a first side in the axial direction of the yoke, a first drum part arranged (disposed) on the first side in the axial direction of the tooth base part, and a first inner wall part arranged (disposed) on the first side in the axial direction of the tooth tip part. The first drum part includes a first side surface on the first side in the circumferential direction and a second side surface on the second side in the circumferential direction. Each stator winding is wound around the respective tooth base part with at least the first drum part being arranged (disposed) on the first side in the axial direction of the tooth base part. The electrical insulation body includes a projection formed at a connection part between the first drum part and the first outer wall part, the projection having an inclined wall surface that connect an inner peripheral surface of the first outer wall part to the first side surface. The stator core includes at least one of a cutout formed in at least one of the tooth second side surface and a yoke inner peripheral surface, the cutout having a recessed shape that recesses toward an opposite side from a slot defined by two circumferentially adjacent teeth. A tooth projection is formed at a connection part between the tooth first side surface and the yoke inner peripheral surface, and protruding toward the slot.

According to the motor of this aspect, even if the electrical insulation body having the projection is formed by insert molding, it is possible to favorably set a flow rate balance of a resin material on the side of the first side surface and on the side of the second side surface. Thus, Thus, it is possible to reduce or prevent molding defects, such as “short shot” and the like, during insert molding of the electrical insulation body.

(2) In the motor according to the above-described aspect, the stator core may include the cutout. The cutout may be provided at a connection part between the tooth second side surface and the yoke inner peripheral surface. The recessed shape of the cutout may include a first portion formed in (on) the yoke inner peripheral surface and a second portion formed in (on) the tooth second side surface.

According to the motor of this aspect, the flow rate of the resin material at the cutout during insert molding can be increased compared to an embodiment in which the cutout is separately provided in (on) the yoke inner peripheral surface and in (on) the tooth second side surface.

(3) In the motor according to the above-described aspect(s), the cutout may include a curved portion having a smaller radius of curvature than the radius of curvature of the connection part between the yoke inner peripheral surface and the tooth first side surface.

According to the motor of this aspect, the flow path resistance of the cutout is reduced, and the flow rate of the resin material at the cutout during insert molding can be increased.

(4) In the motor according to the above-described aspect(s), a cross-sectional surface area of the projection and a cross-sectional surface area of the cutout may be configured (set) to be different from each other.

According to the motor of this aspect, even if the flow rate of the resin material differs at positions other than the connection part between the first drum part and the first outer wall part, the flow rate balance of the resin material during insert molding can be favorably set.

(5) In the motor according to the above-described aspect(s), the stator core may include a tooth projection. The thickness of the electrical insulation body defined from a surface of the tooth projection to a surface of the projection provided on the electrical insulation body, and a thickness of the electrical insulation body defined from the tooth first side surface to a surface of the first drum part of the electrical insulation body may be the same as each other.

According to the motor of this aspect, as a result of making the thickness of the electrical insulation body uniform, it is possible to reduce the likelihood of or even prevent local variations in electrical insulating properties of the stator core.

(6) In the motor according to the above-described aspect(s), the electrical insulation body may further have a second outer wall part arranged (disposed) on a second side in the axial direction of the yoke, a second drum part arranged (disposed) on the second side in the axial direction of the tooth base part, and a second inner wall part arranged (disposed) on the second side in the axial direction of the tooth tip part. The electrical insulation body may have a first electrical insulation part, which includes the first outer wall part, the first drum part, and the first inner wall part, a second electrical insulation part, which includes the second outer wall part, the second drum part, and the second inner wall part, and an insulation body connection part provided (extending) continuously between the first electrical insulation part and the second electrical insulation part without a seam therebetween.

According to the motor of this aspect, it is possible to reduce the number of steps for assembling the electrical insulation body and the stator core, whereby manufacturing productivity of the motor can be improved. Further, even if the total thickness (the length in the axial direction) of the stator changes due to the insulation body connection part being interposed in the axial direction, it is possible to manufacture the motor without having to create a new mold.

(7) According to another aspect of the present disclosure, a compressor comprises a compression mechanism for compressing a refrigerant and outputting pressurized refrigerant and a motor for driving the compression mechanism. The compressor may include the motor according to any of the above-described aspects or any one of the embodiments described below.

The present disclosure can be realized in various aspects other than a motor. For example, the present disclosure can be realized by a stator, a method of manufacturing the stator, a method of manufacturing a motor, and a method of forming a stator winding.

### BRIEF DESCRIPTION OF THE DRAWINGS

FIG. 1 is an explanatory view showing internal structures of a compressor provided with a motor according to a first embodiment of the present teachings.

FIG. 2 is an explanatory view showing a configuration of a stator used in the motor according to the first embodiment.

FIG. 3 is a sectional view showing cross-section III-III indicated in FIG. 2.

FIG. 4 is a perspective view showing an external configuration of an electrical insulation body of the first embodiment.

FIG. 5 is a plan view showing the external configuration of the electrical insulation body.

FIG. 6 is an explanatory view showing area AR2 indicated in FIG. 5 in an enlarged manner.

FIG. 7 is an explanatory view schematically showing a stator winding wound around a drum part according to the first embodiment.

FIG. 8 is an explanatory view showing a configuration of an outer wall part according to the first embodiment.

FIG. 9 is an explanatory view showing grooves according to the first embodiment in an enlarged manner.

FIG. 10 is an explanatory view showing a periphery of a projection according to the first embodiment in an enlarged manner.

FIG. 11 is an explanatory view showing a periphery of a first flange and a second flange according to the first embodiment in an enlarged manner.

FIG. 12 is an explanatory view showing area AR1 indicated in FIG. 3 in an enlarged manner.

FIG. 13 is an explanatory view showing a configuration of a known stator core, as a comparative example.

FIG. 14 is an explanatory view showing a configuration of a stator core for a motor according to a second embodiment.

FIG. 15 is an explanatory view showing a configuration of a stator core for a motor according to a third embodiment.

FIG. 16 is an explanatory view showing a configuration of a stator core for a motor according to a fourth embodiment.

### DETAILED DESCRIPTION OF THE EMBODIMENTS

### A. First Embodiment

### A1. Configuration of Compressor 300 and Motor 310

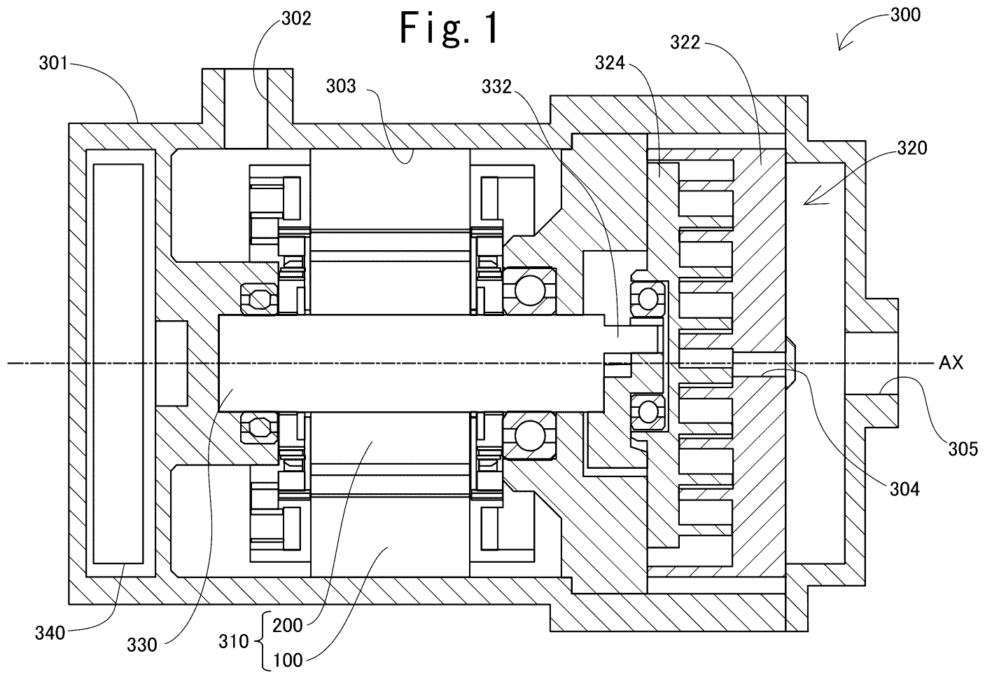

FIG. 1 is an explanatory view showing internal structures of a compressor 300 provided with a motor 310 according to a first embodiment of the present disclosure. The compressor 300 is configured, e.g., as an electric scroll compressor. For example, the compressor 300 may be installed, with an evaporator, an expansion valve, a condenser, etc., in a vehicle (not shown in the drawings) to function as a refrigerant circuit of an in-vehicle air conditioner.

As shown in FIG. 1, the compressor 300 comprises a housing 301, a motor 310, a compression mechanism 320 that compresses a fluid (refrigerant) and outputs compressed fluid, a drive shaft 330, and a drive circuit 340. The housing 301 houses the motor 310 and the compression mechanism 302. An intake port 302, a motor chamber 303 in which the motor 310 is disposed, and a discharge port 305 are formed in the housing 301.

The intake port 302 is in fluid communication with the motor chamber 303. The intake port 302 is fluidly connected, e.g., to an evaporator (not shown in the drawings), receives refrigerant (fluid) supplied from the evaporator and guides the refrigerant to flow into the motor chamber 303. The discharge port 305 discharges pressurized refrigerant compressed by the compression mechanism 320 to the outside of the compressor 300. The discharge port 305 is fluidly connected, e.g., to a condenser (not shown in the drawings).

The drive shaft 330 is a substantially cylindrical member extending along a rotational axis AX. The drive shaft 330 is supported inside the housing 301 so as to be rotatable around the rotational axis AX. An eccentric pin 332 having a substantially cylindrical shape is formed at an end portion of the drive shaft 330. The eccentric pin 332 is arranged at a position offset by a predetermined distance from the rotational axis AX.

The motor 310 generates a driving force to rotate the drive shaft 330 around the rotational axis AX. The motor 310 is an example of an “electric motor” according to the present teachings. The motor 310 includes a stator 100 having a substantially cylindrical shape, and a rotor 200. The stator 100 is fixed to the inner wall defining the motor chamber 303. Coils (hereinbelow, stator windings 90) of the stator 100 are electrically connected to the drive circuit 340. The drive circuit 340 is, for example, an inverter or the like configured to control energization of the motor 310. The rotor 200 is disposed in the interior of the stator 100, so as to be able to rotate relative to the stator 100. The rotor 200 is connected to the drive shaft 330. The drive shaft 330 rotates around the rotational axis AX when the rotor 200 is rotated.

The compression mechanism 320 comprises a fixed scroll 322 and a movable scroll 324. The movable scroll 324 is connected to the drive shaft 330 via the eccentric pin 332. The fixed scroll 322 is fixed to the housing 301. A fluid communication path (opening) 304 is formed in the fixed scroll 322. The fixed scroll 322 and the movable scroll 324 each have wall surfaces arranged in a helical shape, and the helically-shaped wall surfaces are arranged to mesh with each other. As a result, a compression chamber capable of compressing the refrigerant is formed between the fixed scroll 322 and the movable scroll 324. When the motor 310 is energized and the drive shaft 330 rotates round the rotational axis AX, the center of the movable scroll 324 revolves (orbits) around the rotational axis AX and the refrigerant in the compression chamber is thereby compressed. The compressed refrigerant is discharged from the compression mechanism 320 to the discharge port 305 via the fluid communication path 304.

### A2. Configuration of Stator 100

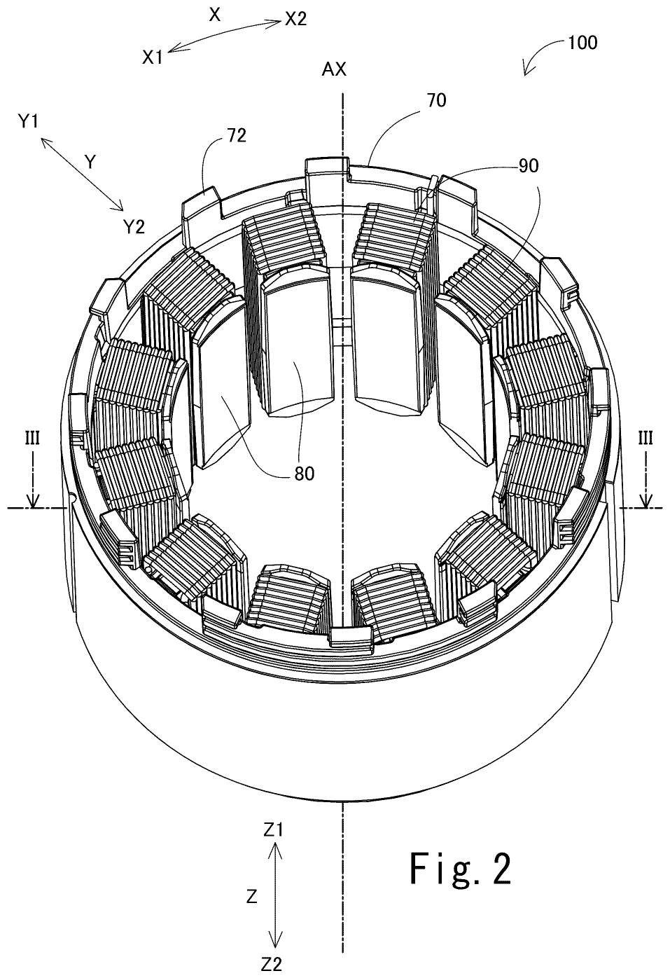

FIG. 2 is an explanatory view showing the configuration of the stator 100 provided in the motor 310 according to the first embodiment. As shown in FIG. 2, the stator 100 comprises a stator core 80, an electrical insulation body 70, and stator windings (coils) 90. FIG. 2 schematically shows three directions used in the present disclosure. “Axial direction Z” refers to the axial direction that is parallel to, or coincides with, the rotational axis AX of the rotor 200. In the axial direction Z, one side of a first outer wall part 72 (described below) is defined as “first side Z1 in the axial direction” and the opposite side is defined as “second side Z2 in the axial direction”, as shown in FIG. 2. When the rotor 200 of the motor 310 is oriented along (coincides with) the vertical direction, the first side Z1 in the axial direction is also sometimes referred to as the “upper side”, and the second direction Z2 in the axial direction is also sometimes referred to as the “lower side”. “Circumferential direction X” refers to the circumferential direction around the rotational axis AX. In the circumferential direction X, when the motor 310 is viewed from the first side Z1 in the axial direction, the counterclockwise direction defines “first side X1 in the circumferential direction” and the clockwise direction defines “second side X2 in the circumferential direction” as shown in FIG. 2. “Radial direction(s) Y” pass(es) through (intersects) the rotational axis AX, and is (are) orthogonal to the rotational axis AX. The term “radial direction Y” refers to a radial direction centered on the rotational axis AX. In the radial direction Y, the side closest to the rotational axis AX defines “inner side Y2 in the radial direction” and the opposite side defines “outer side Y1 in the radial direction”, as shown in FIG. 2.

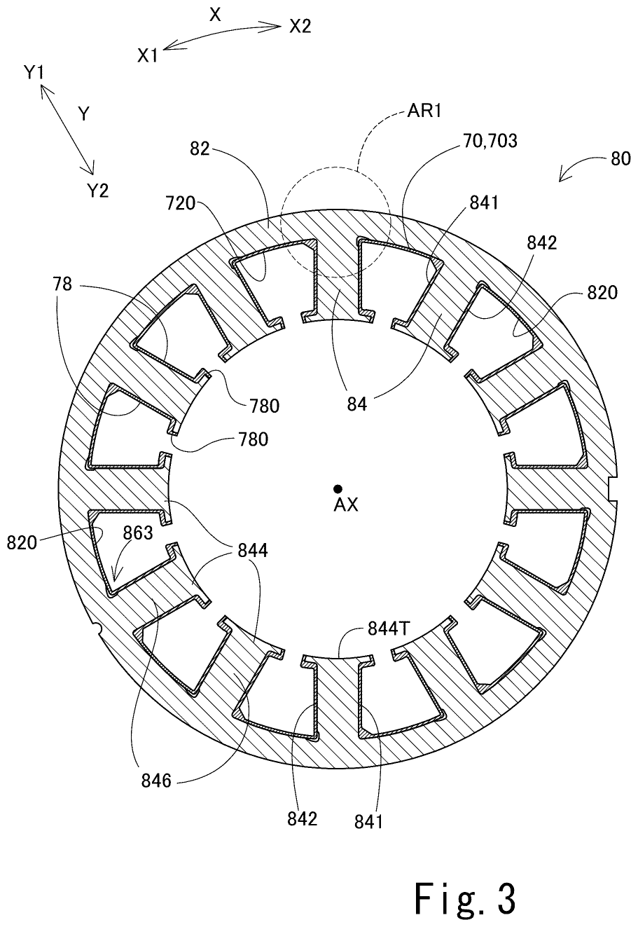

FIG. 3 is a sectional view showing cross-section III-III indicated in FIG. 2. Note that, in FIG. 3, for ease of understanding of the technology, the stator windings 90 are not shown. The stator core 80 is formed of a stack of laminated electromagnetic steel sheets. As shown in FIG. 3, the stator core 80 includes a yoke 82 extending along the circumferential direction X, and a plurality of teeth 84. The electrical insulation body 70 is configured to cover the stator core 80, in order to electrically insulate the stator windings 90 from the stator core 80.

The teeth 84 respectively extend from the yoke 82 radially inward towards the rotational axis AX, namely, toward the inner side Y2 in the radial direction. The teeth 84 are spaced apart (preferably equidistantly) from each other in the circumferential direction X. Slots 78 are respectively defined by (between) circumferentially-adjacent ones of the teeth 84. The number of teeth 84 can set as appropriate for the particular application of the present teachings.

Each of the teeth 84 has a tooth base part 846 and a tooth tip part 844. The tooth base part 846 is connected to a yoke inner peripheral surface 820 of the yoke 82. The tooth base part 846 is a portion extending from the yoke inner peripheral surface 820 of the yoke 82 toward the inner side Y2 in the radial direction, i.e. radially inward. The portion at which the tooth base part 846 and the yoke 82 are connected is also referred to as “connection part 863”. The tooth base part 846 has a tooth first side surface 841 on the first side X1 in the circumferential direction and a tooth second side surface 842 on the second side X2 in the circumferential direction.

The tooth tip part 844 extends continuously from the tip end of the tooth base part 846 on the inner side Y2 in the radial direction. As shown in FIG. 3, the sides of each tooth tip part 844 extend from the tip end of the tooth base part 846 toward the first side X1 in the circumferential direction and toward the second side X2 in the circumferential direction, respectively. A stator core inner space, in which the rotor 200 is rotatably arranged, is defined by tooth tip end surfaces 844T of the tooth tip parts 844, which are each located on the inner side Y2 in the radial direction.

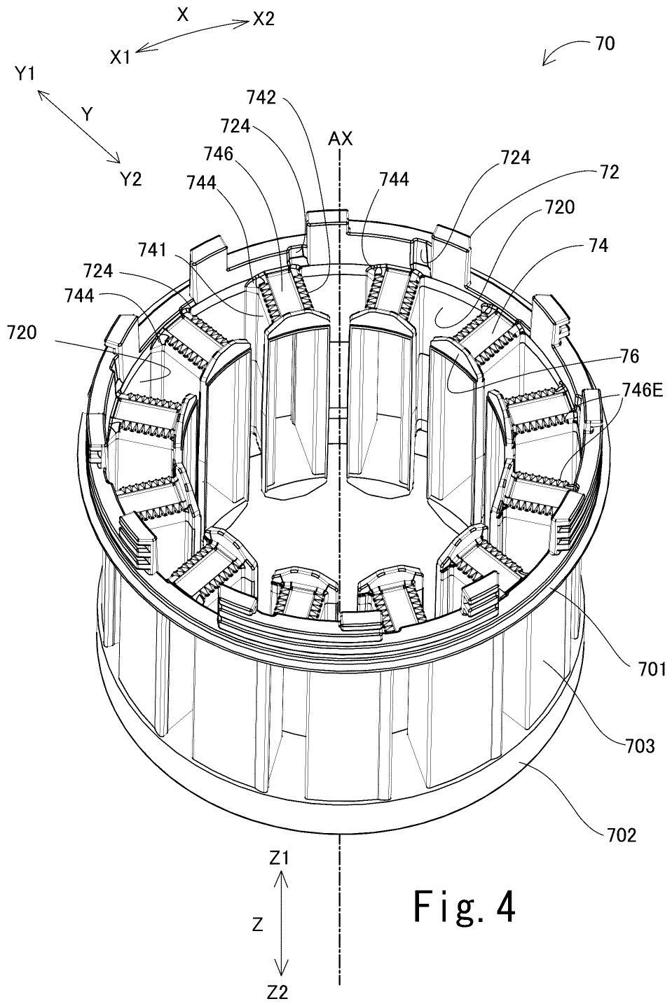

As shown in FIG. 3, each slot 78 is a space defined by two of the teeth 84 that are adjacent to each other in the circumferential direction X and the yoke inner peripheral surface 820 of the stator core 80. Each slot opening 780 is defined by the tooth tip part 844 of one of the teeth 84 located on the first side X1 in the circumferential direction and the tooth tip part 844 of another one of the teeth 84 located on the second side X2 in the circumferential direction. In a concentrated winding method, each stator winding 90 is wound around a respective drum part 74 (FIG. 4) by inserting a needle into the slot 78 via the slot opening 780, from the inner side of the electrical insulation body 70, and moving the inserted needle.

### A3. Configuration of Electrical Insulation Body 70

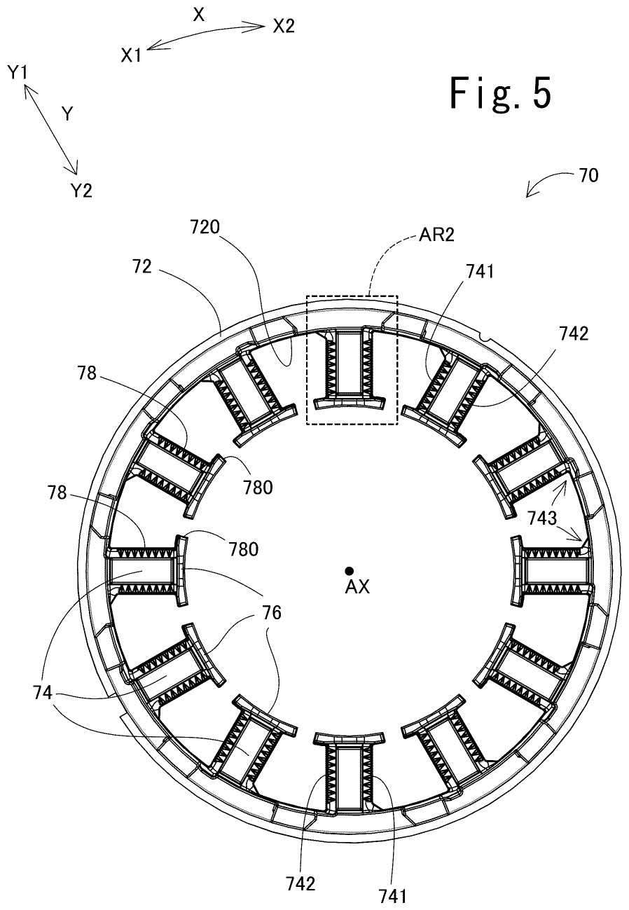

The configuration of the electrical insulation body 70 is now described with reference to FIGS. 4 to 6. FIG. 4 is a perspective view showing the external configuration of the electrical insulation body 70. FIG. 5 is a plan view showing the external configuration of the electrical insulation body 70. The electrical insulation body 70 is formed of a polymer (resin) having electrical insulating properties. The electrical insulation body 70 may also be referred to herein as a “plastic bobbin” or “resin bobbin”. As shown in FIG. 4, the electrical insulation body 70 includes a first electrical insulation part 701 arranged on the first side Z1 in the axial direction of the stator core 80, a second electrical insulation part 702 arranged on the second side Z2 in the axial direction of the stator core 80, and an insulation body connection part 703. Note that the electrical insulation body 70 is not limited to being formed of a polymer (resin), and may be formed of a material other than polymer (resin).

The insulation body connection part 703 extends continuously between the first electrical insulation part 701 and the second electrical insulation part 702. In the present embodiment, as shown in FIGS. 3 and 4, the insulation body connection part 703 is formed to face the inner circumferential surface of the stator core 80. Specifically, the insulation body connection part 703 is formed to be disposed on the yoke inner peripheral surface 820, the tooth first side surface 841 of each tooth 84 and the tooth second side surface 842 of each tooth 84.

In the present embodiment, the electrical insulation body 70 is formed by insert molding (injection molding). Specifically, a resin material is introduced (injected) into a die mold with the stator core 80 disposed in the interior of the die mold, and the resin material is then cured (hardened, polymerized) to form the electrical insulation body 70. As a result, the electrical insulation body 70 is formed in a state in which the stator core 80 is housed in the interior thereof, and in a state in which the first electrical insulation part 701, the second electrical insulation part 702, and the insulation body connection part 703 are integrally formed without a seam therebetween.

The first electrical insulation part 701 includes a plurality of first outer wall parts 72 arranged (disposed) on the first side Z1 in the axial direction of the yoke 82, a plurality of first drum parts 74 arranged (disposed) on the first side Z1 in the axial direction of the respective tooth base parts 846, and a plurality of first inner wall parts 76 arranged (disposed) on the first side Z1 in the axial direction of the respective tooth tip part 844. The second electrical insulation part 702 includes a plurality of second outer wall parts arranged (disposed) on the second side Z2 in the axial direction of the yoke 82, a plurality of second drum part arranged (disposed) on the second side Z2 in the axial direction of the respective tooth base parts 846, and a plurality of second inner wall part arranged (disposed) on the second side Z2 in the axial direction of the respective tooth tip parts 844. The second outer wall parts, the second drum parts, and the second inner wall parts are formed, on the second side Z2 in the axial direction, at positions respectively corresponding to the first outer wall parts 72, the first drum parts 74, and the first inner wall parts 76. The configurations of the second outer wall parts, the second drum parts, and the second inner wall parts are the same as those of the first outer wall parts 72, the first drum parts 74, and the first inner wall parts 76, and therefore need not be further described. The insulation body connection part 703 includes a plurality of third outer wall parts arranged (disposed) on the inner side Y2 in the radial direction of the yoke inner peripheral surface 820 of the yoke 82, a plurality of third drum parts arranged (disposed) on the first side X1 in the circumferential direction of the tooth base part 846, a plurality of fourth drum parts arranged (disposed) on the second side X2 in the circumferential direction of the tooth base part 846, a plurality of third inner wall parts arranged (disposed) on the first side X1 in the circumferential direction of the tooth tip part 844, and a plurality of fourth inner walls part (disposed) arranged on the second side X2 in the circumferential direction of the tooth tip part 844. In the present specification, when no particular distinction is made between the first outer wall part(s) 72, the second outer wall part(s), and the third outer wall part(s), they can also be simply (collectively) referred to as the “outer wall part(s) 72”; similarly, when no particular distinction is made between the first drum part(s) 74, the second drum part(s), the third drum part(s), and the fourth drum part(s), they can also be simply (collectively) referred to as the “drum part(s) 74”; finally, when no particular distinction is made between the first inner wall part(s) 76, the second inner wall part(s), the third inner wall part(s), and the fourth inner wall part(s), they can also be simply referred (collectively) to as the “inner wall part(s) 76”.

As shown in FIG. 4, the outer wall parts 72 are portions of the first electrical insulation part 701 that extend further toward the first side Z1 in the axial direction than the drum parts 74. Lead wires that form connections between the stator windings 90 are wound around the drum parts 74 and are respectively arranged (disposed) on the outer wall part 72. Grooves 724 (described below) are respectively formed in the outer wall parts 72.

Each drum part 74 is a portion of the first electrical insulation part 701 around which one of the stator windings 90 is wound. Portions of the first electrical insulation part 701 that respectively connect one of the drum parts 74 to one of the outer wall parts 72 are also referred to as “connection parts 743”. As shown in FIG. 5, each of the drum parts 74 has a first side surface 741 on the first side X1 in the circumferential direction and a second side surface 742 on the second side X2 in the circumferential direction. The first side surface 741 is arranged (disposed) on the first side X1 in the circumferential direction of the tooth first side surface 841 of the stator core 80 and the second side surface 742 is arranged (disposed) on the second side X2 in the circumferential direction of the tooth second side surface 842. Note that the first side surface 741 is included in the (each) third drum part and the second side surface 742 is included in the (each) fourth drum part.

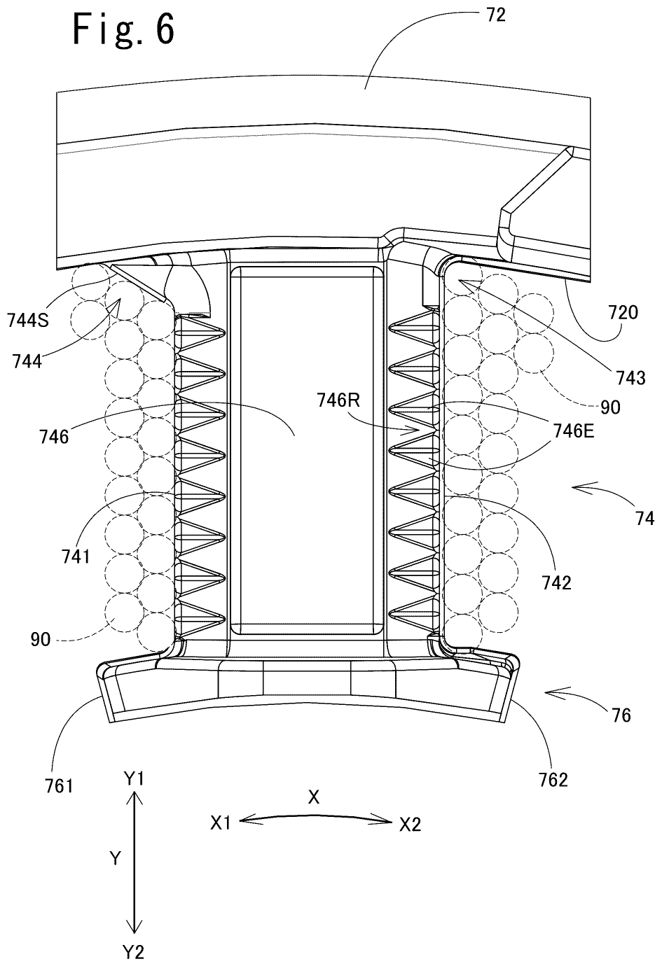

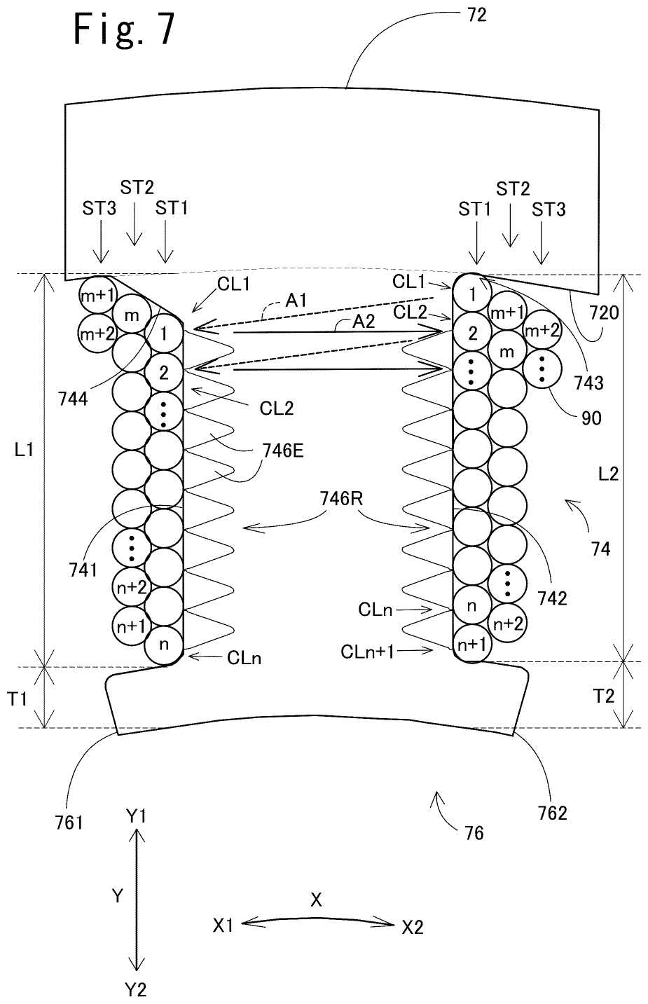

FIG. 6 is an explanatory view showing rectangular area AR2, which is indicated with a dashed line in FIG. 5, in an enlarged manner. In the electrical insulation body 70, each connection part 743 connecting one of the drum parts 74 and one of the outer wall parts 72 includes a projection 744 formed on the same side as the first side surface 741 (see also FIG. 7). The (each) projection 744 is configured to protrude (extend) from the inner peripheral surface 720 toward the inner side Y2 in the radial direction (i.e. radially inwardly), and to protrude (extend) from the first side surface 741 toward the first side X1 in the circumferential direction. The (each) projection 744 is formed to extend along the entire length of the (respective) drum part 74 in the axial direction Z (refer to FIG. 4). In other words, in the present embodiment, the electrical insulation body 70 includes (i) the projections 744 respectively formed at each connection part 743 that connects one of the first drum parts 74 and one of the first outer wall parts 72 in the first electrical insulation part 701, (ii) second projections each having a second inclined surface and formed at each connection part 743 that connects one of the second drum parts and one of the second outer wall parts in the second electrical insulation part 702, and (iii) third projections each having a third inclined surface and formed at each connection part 743 that connects one of the third drum parts and one of the third outer wall parts in the insulation body connection part 703. By providing the inclined wall surfaces on both the first side Z1 in the axial direction and the second side Z2 in the axial direction and between the first side Z1 in the axial direction and the second side Z2 in the axial direction, the rows of each of the stator windings 90 can be more easily arrayed in the radial direction Y Thus, it is possible to more reliably reduce the likelihood of or even prevent the rows of the stator winding 90 from becoming misaligned, e.g., in the radial direction. The (each) projection 744 need not necessarily be provided along the entire length of the (each) connection part 743 of the (each) drum part 74, and may instead be formed only along a portion of the connection part 743. For example, the projections 744 may be formed only at the connection parts 743 that respectively connect the first drum parts 74 and the first outer wall parts 72. At least one of the second projection(s) and the third projection(s) may be omitted. Further, a plurality of the projections 744 may be provided at each one of the connection parts 743.

Each projection 744 includes the inner peripheral surface 720 of the (corresponding) outer wall part 72, and an inclined wall surface 744s connected to the (corresponding) first side surface 741. When winding one of the stator windings 90 on the first side surface 741, the portion of the stator winding 90 that is in contact with the projection 744 can be guided along the inclined surface 744s toward the correct arrangement position. Further, the projection 744 can restrict (block) the stator winding 90 from moving toward the outer side Y1 in the radial direction, i.e. radially outwardly. By providing the projection 744, it is possible to reduce the likelihood of or even prevent the stator windings 90 respectively wound around the drum parts 74 from being wound such that the lead wires (or portions of a single lead wire) thereof cross each other.

Referring to FIGS. 4 and 6, the surface of the (each) drum part 74 on the first side Z1 in the axial direction is defined as a first end surface 746, and a plurality of protrusions 746E are formed on the first end surface 746. The protrusions 746E are arrayed in (along) the extending (radial) direction of the drum part 74. Each of the protrusions 746E protrudes from the first end surface 746 toward the first side Z1 in the axial direction. More specifically, each protrusion 746E has a substantially triangular pyramid outer shape and is configured such that the apex thereof protrudes from the first end surface 746 toward the first side Z1 in the axial direction. A recess 746R is defined between each pair of protrusions 746E that are adjacent to each other in the radial direction. The recesses 746R restrict (constrain) the rows of the stator winding 90 disposed on the first end surface 746 from moving (shifting) in the radial direction Y. The recesses 746R are spaced apart from each other at equal intervals. As a result, the wire of the stator winding 90 disposed on the first end surface 746 is easily arrayed in rows so that portions of the wire are parallel to each other, and it is possible to reduce the likelihood of or even prevent the lead wires (or portions of a single lead wire) that form the stator windings 90 from being wound around the drum parts 74 while crossing each other.

As shown in FIG. 6, each of the inner wall parts 76 includes a first flange 761 that protrudes from the drum part 74 toward the first side X1 in the circumferential direction, and a second flange 762 that protrudes from the drum part 74 toward the second side X2 in the circumferential direction. The first flange 761 and the second flange 762 block the stator winding 90 wound around the drum part 74 from moving (shifting) further toward the inner side Y2 in the radial direction, i.e. from shifting radially inward. In the present embodiment, as will be described later, a largest thickness of the second flange 762 in the radial direction Y is configured (set) to be thicker than a largest thickness of the first flange 761 in the radial direction Y.

### A4. Configuration of Stator Winding 90

FIG. 7 is an explanatory view schematically showing one of the stator windings 90 wound around one of the drum parts 74. More specifically, FIG. 7 schematically shows (i) distance L1 in the radial direction Y from the radially outer surface (wall surface) of the first flange 761 to the inner peripheral surface 720 and (ii) distance L2 in the radial direction Y from the radially outer wall surface of the second flange 762 to the inner peripheral surface 720. Furthermore, FIG. 7 also schematically shows (i) thickness (i.e. largest thickness) T1 in the radial direction Y of the first flange 761 and (ii) thickness (i.e. largest thickness) T2 in the radial direction Y of the second flange 762. Note that, in FIG. 7, for ease of understanding of the technology, the configuration (shape) of each of the parts is simplified. In the present specification, for convenience in the description, the lead wire(s) forming the stator windings 90 may also sometimes simply be referred to as the “stator winding(s) 90”.

An exemplary, non-limiting method for winding the stator windings 90 is now described. The lead wire that will form the stator winding 90 is guided from the (corresponding) outer wall part 72 to the (corresponding) drum part 74 via (though) the (corresponding) groove 724, as shown in FIG. 4. Then, the lead wire that will form the stator winding 90, which has been guided to the drum part 74, is repeatedly wound around the drum part 74 one turn at a time, and is thus arrayed in the radial direction Y. Numbers shown inside the stator winding 90 in FIG. 7 schematically indicate an exemplary order for winding the stator winding 90. The numbers inside the stator winding 90 are individually shown on the first side surface 741 and on the second side surface 742. In the present embodiment, the order of winding is from the second side surface 742 to the first side surface 741.

As shown by the number “1” on the right side in FIG. 7, the wire that will form the stator winding 90 is first guided from the outer wall part 72 to the vicinity of the connection part 743 between the second side surface 742 and the inner peripheral surface 720. In the present specification, a unit of the array of the stator winding 90 in the radial direction Y is referred to as a “row” and a unit of the array of the stator winding 90 in the circumferential direction X is referred to as a “stage” or “layer”. In the example shown in FIG. 7, the radially outermost side in the radial direction Y of first stage ST1 is the position of a first row CL1 of a first row of winding of the stator winding 90.

The wire that forms the stator winding 90 first passes over (extends along) the second side surface 742 in the axial direction Z. Then, as shown by arrow A1 in FIG. 7, the stator winding 90 bends to pass over (extend along) the second end surface side of the drum part 74 on the opposite side from the first end surface 746, from the second side X2 in the circumferential direction to the first side X1 in the circumferential direction. As shown by the number “1” on the left side in FIG. 7, the portion of the stator winding 90 that has passed over the second end surface is then guided to the first side surface 741, and passes over (extends along) the first side surface 741 in the axial direction Z. As shown by arrow A2 in FIG. 7, the stator winding 90 that has passed over (extended along) the first side surface 741 is then guided over the first end surface 746 from the first side X1 in the circumferential direction toward the second side X2 in the circumferential direction. In this way, the winding of one turn of the stator winding 90 on the drum part 74 is completed.

The stator winding 90 is then guided again to the second side surface 742, and the above-described winding procedure is repeated in the same way in an ongoing manner until the winding of the stator winding 90 has been completed. Specifically, as shown by the number “2” on the right side in FIG. 7, from a second row CL2 onward, the rows are arrayed in order from the first row CL1 toward the inner side Y2 in the radial direction so as to be adjacent to each other. As shown by the number “n+1” on the right side in FIG. 7, the array (rows) of the stator winding 90 of the first stage ST1 is complete when the stator winding 90 reaches the inner wall part 76. When the array (rows) of the stator winding 90 of the first stage ST1 is complete, as shown by the number “n+2” on the right side in FIG. 7, the lead wire forming the stator winding 90 is wound on top of the first stage ST1 on the second side X2 in the circumferential direction (i.e. on top of the innermost layer of the wire that forms the stator winding 90). Note that, at the first side surface 741, the stator winding 90 is wound on top of the first stage ST1 on the first side X1 in the circumferential direction. The array of a second stage (layer) ST2 of the stator winding 90 is started toward the outer side Y1 in the radial direction, and the same process is also repeated from a third stage ST3 onward.

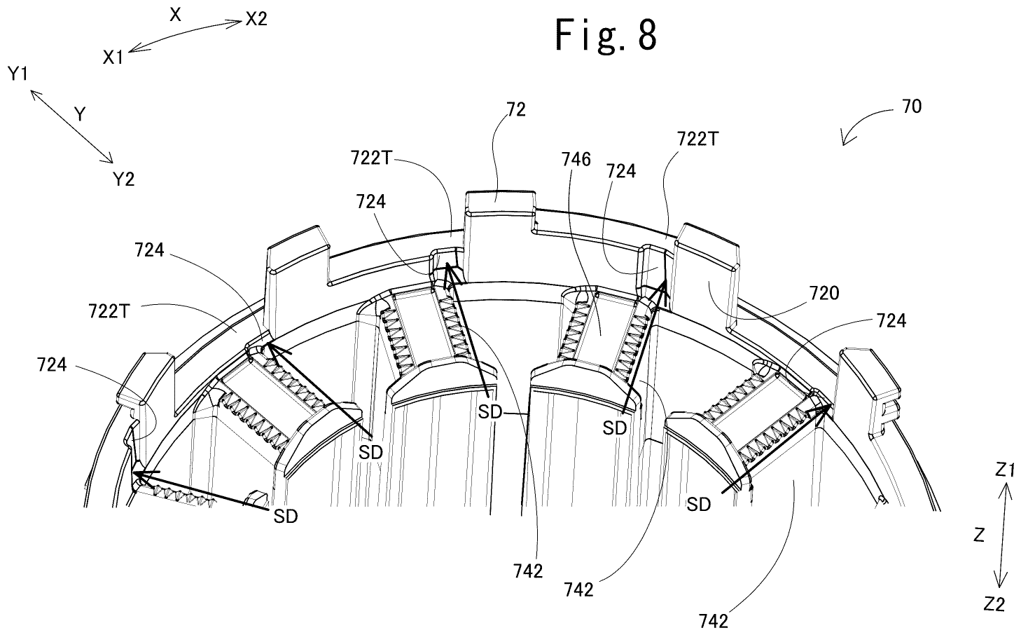

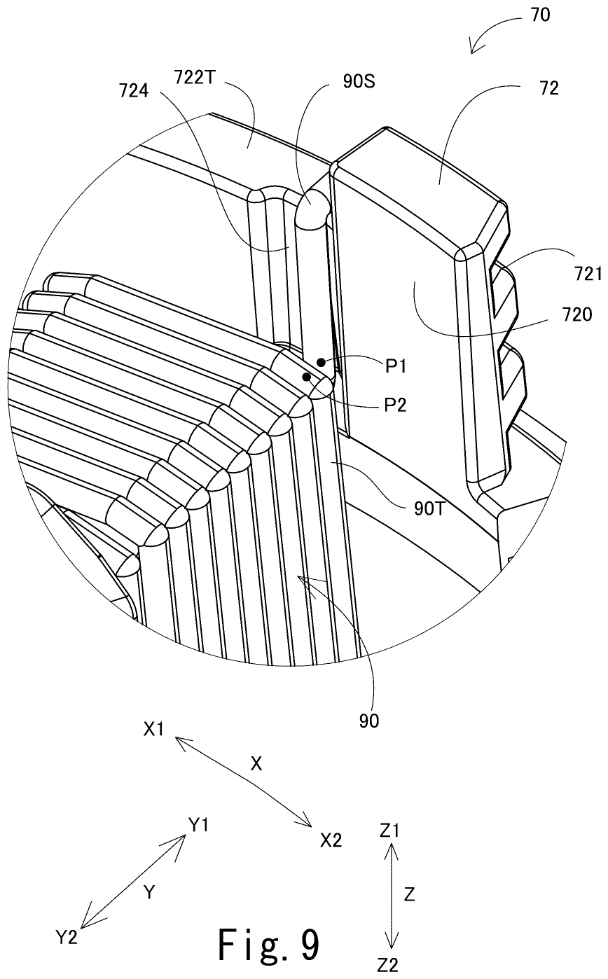

The configuration of the groove 724 defined in the inner peripheral surface 720 of the outer wall part 72 is now described with reference to FIGS. 8 and 9. FIG. 8 is an explanatory view of the configuration of the outer wall parts 72. As shown in FIG. 8, the (each) groove 724 is provided at a position at which the surface direction SD of the second side surface 742 intersects the inner peripheral surface 720 of the outer wall part 72, and in the vicinity of that position. That is, the groove 724 is formed on an extension of the second side surface 742 and in the vicinity thereof. Further, in the axial direction Z, the groove 724 extends along the inner peripheral surface 720 from a position in the vicinity of the first end surface 746 of the adjacent drum part 74 to a top end 722T of the adjacent outer wall part 72. In other words, the groove 724 is provided to serve as an introduction path for the stator winding 90 from the outer wall part 72 to the drum part 74.

FIG. 9 is an explanatory view showing one of the grooves 724 in an enlarged manner. As shown in FIG. 9, in the present embodiment, the depth of the (each) groove 724 is configured to be substantially the same as the diameter of the lead wire forming the (corresponding) stator winding 90. Thus, the radially inner surface of the lead wire that passes through the groove 724 is at least substantially flush with the inner peripheral surface 720. That is, by providing the groove 724 in the inner peripheral surface 720 such that the introduction path for the stator winding 90 extends from the outer wall part 72 to the second side surface 742, the wire forming the stator winding 90 can be radially outwardly displaced or disposed (as compared to an insulator that does not include such a groove 724) by an amount (distance) corresponding to the depth of the groove 724. Thus, for example, it is possible to reduce the likelihood of or even prevent a portion 90S of the stator winding 90 that is guided from the outer wall part 72 to the second side surface 742, e.g., at position P1 shown in FIG. 9, from interfering with another portion 90T of the stator winding 90 (which forms the second stage ST2 and/or the following stages), e.g., at position P2 shown in FIG. 9. Note that the depth of the groove 724 is not limited to being substantially the same as the diameter of the lead wire, and may instead be configured to be larger than the diameter of the lead wire. In the alternative, the depth of the groove 724 may be configured to be smaller than the diameter of the stator winding 90. Note that the groove 724 also can be omitted in some applications of the present teachings.

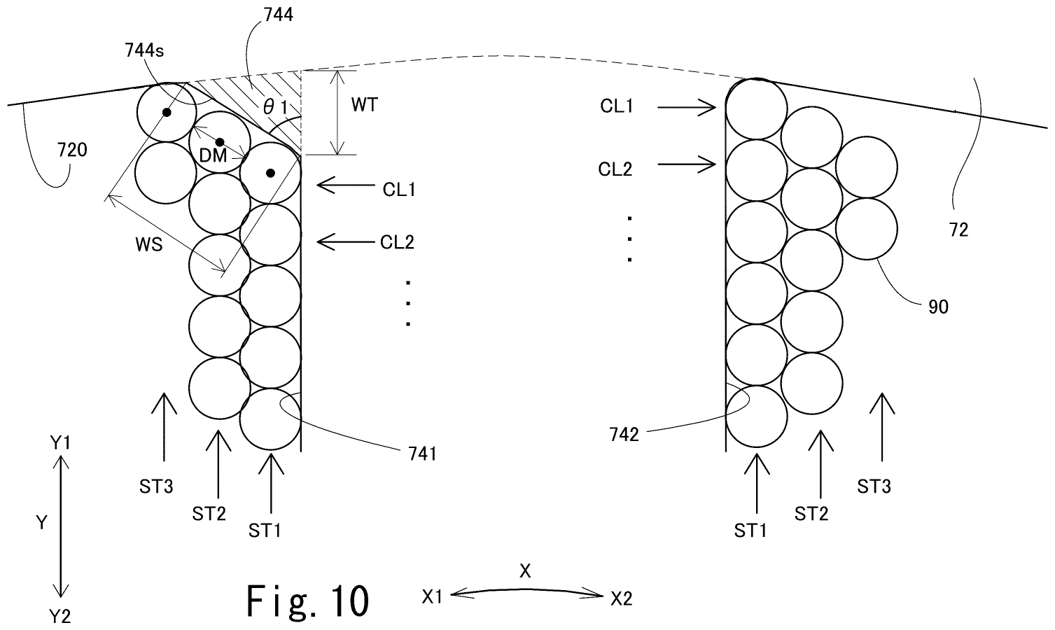

FIG. 10 is an explanatory view showing the periphery of the projection 744 in an enlarged manner. As shown in FIG. 10, as long as the rows of the stator winding 90 can be aligned to achieve a close packed structure in which gaps between the rows and stages of the stator winding 90 are at least substantially minimized, the space factor of the stator winding 90 can be improved. If the inner peripheral surface of the projection 744 includes the inclined wall surface 744s, the portion of the stator winding 90 located at the radially outermost side can be wound so as to contact the inclined wall surface 744s.

In the present embodiment, the inclined wall surface 744s is a flat surface that extends in the direction from the first side X1 in the circumferential direction to the second side X2 in the circumferential direction and is inclined (relative to a tangent of the circumferential direction) in the direction from the outer side Y1 in the radial direction toward the inner side Y2 in the radial direction. By utilizing this kind of configuration, the portions of the first stage ST1, the second stage ST2, and the third stage ST3 of the array of the stator winding 90 located on the outermost side in the radial direction Y can be restricted (blocked, constrained) in the surface direction of the inclined wall surface 744s. Further, in the present embodiment, a configuration is utilized in which an inclination angle θ1 between the surface direction of the inclined wall surface 744s and the extension direction of the drum part 74 (i.e. the radial direction in the present embodiment) is approximately 55 degrees. By utilizing this kind of configuration, the stator winding 90 is arrayed (wound) so as to be a close packed structure, and thus, the space factor of the stator winding 90 can be improved. Note that, if the inclination angle θ1 were to be set to 60 degrees in the present embodiment, an error (tolerance) of 5 degrees is provided that takes into account variations in the diameter of the stator winding 90 and variations in an arrangement position of the stator winding 90. In this way, a reduction in the number of rows of the stator winding 90 per stage (i.e. from an optimal or ideal number of rows per stage) caused by variations in the diameter of the stator winding 90 and variations in arrangement positions of portions of the stator winding 90 can be avoided. Note that the inclined wall surface 744s is not limited to being the flat surface shown in FIG. 10 and may instead be, e.g., a curved surface. In this case, the inclined wall surface 744s may be, e.g., a curved surface having a convex shape that protrudes radially inward, that is, toward the slot 78 side, or alternately may be a curved surface having a concave shape that recesses radially outward, that is, toward the opposite side from the slot 78.

Note also that the inclination angle θ1 is not limited to being only 55 degrees. As was noted above, the inclination angle θ1 can be, e.g., 60 degrees. More generally, the inclination angle θ1 is preferably equal to or greater than 40 degrees. If the inclination angle θ1 were to be less than 40 degrees, then portions of the stator winding 90 located, e.g., on the outermost side in the radial direction Y of the second stage ST2 are more likely to shift toward the first stage ST1, whereby the space factor may be reduced. Further, the inclination angle θ1 is preferably equal to or less than 70 degrees. If the inclination angle θ1 were to be greater than 70 degrees, the space in which the stator winding 90 can be arrayed in the radial direction Y becomes smaller, and there is a possibility that the number of rows of the stator winding 90 per stage may be reduced, whereby the space factor would be reduced.

As shown in FIG. 10, the inclined wall surface 744s has a cross-sectional width WS. Here, the cross-sectional width WS of the inclined wall surface 744s refers to the width (distance) from the inner peripheral surface 720 of the outer wall part 72 to the first side surface 741. In the present embodiment, the cross-sectional width WS is configured (set) to be approximately 2.2 times the diameter DM of the lead wire forming the stator winding 90. By utilizing this kind of configuration, in the three stages from the first stage ST1 to the third stage ST3, the portion of the stator winding 90 at the outermost side in the radial direction Y is arrayed so as to be a close packed structure, and it is possible to improve the space factor of the stator winding 90 over the plurality of stages (layers) of the stator winding 90.

Note that the cross-sectional width WS is not limited to only being 2.2 times the diameter DM. More generally, the cross-sectional width WS is preferably set to be equal to or greater than, e.g., 1.5 times the diameter DM. By utilizing this kind of configuration, it is possible to array the radially outermost portion of the stator winding 90 so as to be a close packed structure in at least the first two stages, namely in the first stage ST1 and the second stage ST2. On the other hand, if the cross-sectional width WS were to be less than 1.5 times the diameter DM, then it might become difficult to optimally align the rows of the stator winding 90 of the second stage ST2 onward. Furthermore, the cross-sectional width WS is also preferably set to be equal to or less than, e.g., 3 times the diameter DM. On the other hand, if the cross-sectional width WS were to be more than 3 times the diameter DM, then the size of the projection 744 would become excessive, whereby the number of rows of the stator winding 90 that can be arranged in the first stage ST1 might be reduced, thereby reducing, e.g., the space factor.

As shown in FIG. 10, the projection 744 has a (largest) thickness (depth) WT in the radial direction Y. In the present embodiment, the thickness WT is determined in accordance with the design of the cross-sectional width WS and the inclination angle θ1 based on the particular application of the present teachings. However, it is noted that the thickness WT may also be set using the distance from the projection 744 to the first flange 761 in the radial direction Y. For example, by setting (selecting) the thickness WT such that the distance from the projection 744 to the first flange 761 in the radial direction Y is an integer multiple of the diameter DM, it is possible to reduce the likelihood of or even prevent gaps from occurring between the rows of the stator winding 90 arranged on the first side surface 741.

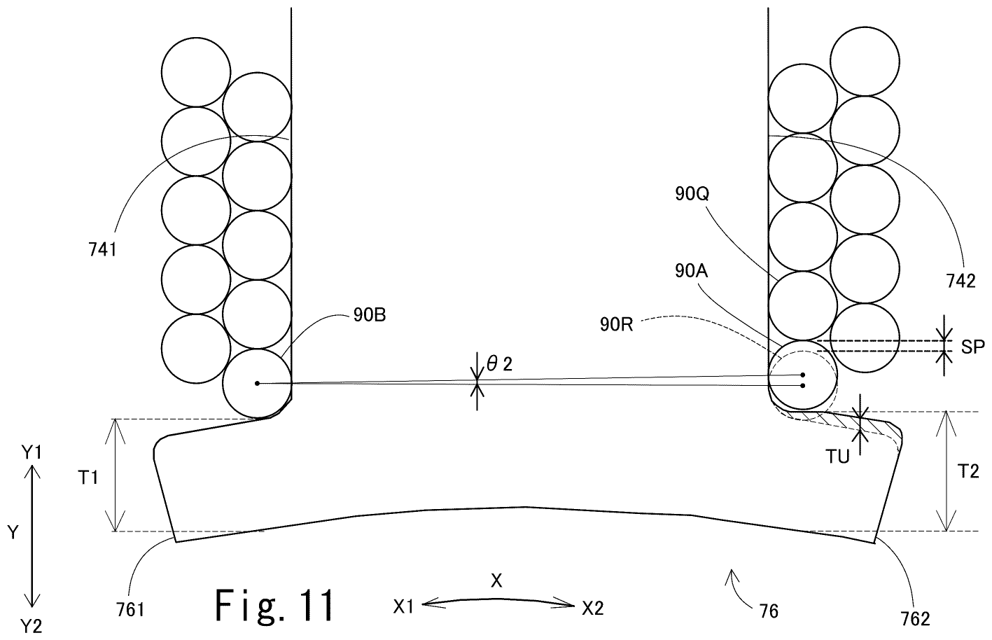

The configuration of the inner wall part 76 is now described with reference to FIG. 11. FIG. 11 is an explanatory view showing the periphery of the first flange 761 and the second flange 762 in an enlarged manner. As shown in FIG. 11, in the present embodiment, the (largest) thickness T2 of the second flange 762 in the radial direction Y is configured (set) to be thicker than the (largest) thickness T1 of the first flange 761 in the radial direction Y. More specifically, the thickness T2 of the second flange 762 in the radial direction Y is configured (set) to be thicker than the thickness T1 of the first flange 761 in the radial direction Y by the thickness amount TU; i.e. T2=T1+TU. By increasing the thickness T2 of the second flange 762 (as compared to the thickness T1 of the first flange 761), the locations of the rows of the stator winding 90 arrayed on the second side surface 742 can be offset (shifted) towards the outer side Y1 in the radial direction (as compared to the rows of the stator winding on the first side surface 741) by an amount corresponding to the thickness amount TU. Note that the combined (summed) value of the distance L1 shown in FIG. 7 and the thickness T1, and the combined (summed) value of the distance L2 and the thickness T2 are preferably the same or at least substantially the same (e.g., preferably within 0-5% of each other). The distance from the inner wall part 76 to the rotor 200 in the radial direction is substantially constant across the first flange 761 and the second flange 762 in the circumferential direction. Further, the distance from the inner peripheral surface 720 to the tip end surface of the inner wall part 76 in the radial direction is constant or at least substantially constant (e.g., deviations are preferably within 0-5% of an average value of this distance).

In FIG. 11, as a comparative example, position 90R of the radially inner-most row of the first stage ST1 of the stator winding 90 is shown for an embodiment in which the thickness of the second flange 762 is not increased by thickness amount TU (i.e. in an embodiment in which T1=T2). In such a comparative example, a gap SP can occur between the portion of the lead wire of the stator winding 90 located at the position 90R and the portion of the lead wire of the stator winding 90 located at position 90Q adjacent to the position 90R. If such a gap SP were to occur, a portion of the lead wire of the stator winding 90 in the second stage ST2 or outer stage could displace (move) into the gap SP towards the second surface 742, whereby the space factor may be reduced. In the present embodiment, by setting the thickness amount TU to a thickness equivalent to (or substantially equivalent to, e.g., within 0-5% of) the gap SP, the likelihood of the occurrence of such a gap SP is at least substantially reduced. By utilizing a configuration in which the radially inner-most rows of the stator winding 90 can be arrayed in a close packed structure, the space factor of the stator winding 90 can be improved.

Note that when, for example, the distance L2 in the radial direction Y from the wall surface on the outer side Y1 in the radial direction of the second flange 762 shown in FIG. 7 to the inner peripheral surface 720 is divided by the diameter DM, the thickness amount TU may be set using a remainder that is not divisible (also referred to as a “surplus”). That is, the thickness amount TU can be determined using a simple method in which the calculated remainder is estimated to be the size of the gap SP.

The thickness amount TU may be set using the diameter DM of the lead wire forming the stator winding 90. For example, the thickness amount TU can be set to 0.5 times the diameter DM of the lead wire forming the stator winding 90. By utilizing this kind of configuration, it is possible to reduce the likelihood of or even prevent (a) gaps from occurring between rows of the stator winding 90 on the second side surface 742, (b) undesired displacement of outer stages of the stator winding 90 toward the first stage ST1, and the like. The thickness amount TU is preferably set to be equal to or greater than, e.g., 0.25 times the diameter DM. On the other hand, if the thickness amount TU were to be less than 0.25 times the diameter DM, then gaps may occur between rows of the stator winding 90 and/or rows of the stator winding 90 may be misaligned. Furthermore, the thickness amount TU is preferably set to be less than, e.g., 1.0 times the diameter DM. On the other hand, if the thickness amount TU were to be equal to or greater than 1.0 times the diameter DM, then it might lead to a reduction of the number of rows of the stator winding 90 that can be arranged on the second side surface 742.

As shown in FIG. 11, the second flange 762 extends from the second side surface 742, which is the side surface on the opposite side from the first side surface 741 on which the projection 744 of the drum part 74 is formed. In other words, in the circumferential direction X, the thickness of the flange on the opposite side from the projection 744, with the drum part 74 interposed therebetween, is increased. By increasing the thickness T2 of the second flange 762 on the opposite side from the projection 744, it is possible to offset the relative arrangement position of the rows of the stator winding 90 arrayed on the second side surface 742 relative to the arrangement position of the rows of the stator winding 90 arrayed on the first side surface 741, by an amount corresponding to the size of the projection 744.

In the present embodiment, the position of the rows of the stator winding 90 on the second side surface 742 is offset in the radial direction Y relative to the position of the rows of the stator winding 90 on the first side surface 741 parallel to the second side surface 742. In the example shown in FIG. 11, the position of the row 90A of the stator winding 90 that contacts the second flange 762 on the side of the second side surface 742 is offset by an angle θ2 to the outer side Y1 in the radial direction with respect to the position of the row 90B of the stator winding 90B that contacts the first flange 761 on the side of the first side surface 741. Note that, if the rows of the stator winding 90 on the second side surface 742 were to be (hypothetically) arrayed in parallel to the stator winding 90 on the first side surface 741 in the circumferential direction X as shown by the arrangement position 90R, then the angle θ2 would be zero. In preferred embodiments, the angle θ2 is preferably in the range of, e.g., 1-5 degrees.

In the present embodiment, by winding the rows of the stator winding 90 such that the rows are inclined (offset) toward the outer side Y1 in the radial direction by the angle θ2 with respect to a parallel arrangement, it is possible to perform the winding while applying a force in a direction toward the outer side Y1 in the radial direction. Thus, it is possible to wind the subsequent stator winding 90 while causing the stator winding 90 to be adjacent to the already wound stator winding 90 on the outer side Y1 in the radial direction. It is possible to reduce the likelihood of or prevent the array of the rows of the stator winding 90 from becoming misaligned. Note that, as shown in FIG. 6, the recesses 746R on the side of the second side surface 742 are offset by the thickness amount TU corresponding to the angle θ2 relative to the recesses 746R on the side of the first side surface 741.

### A5. Configuration of Stator Core 80

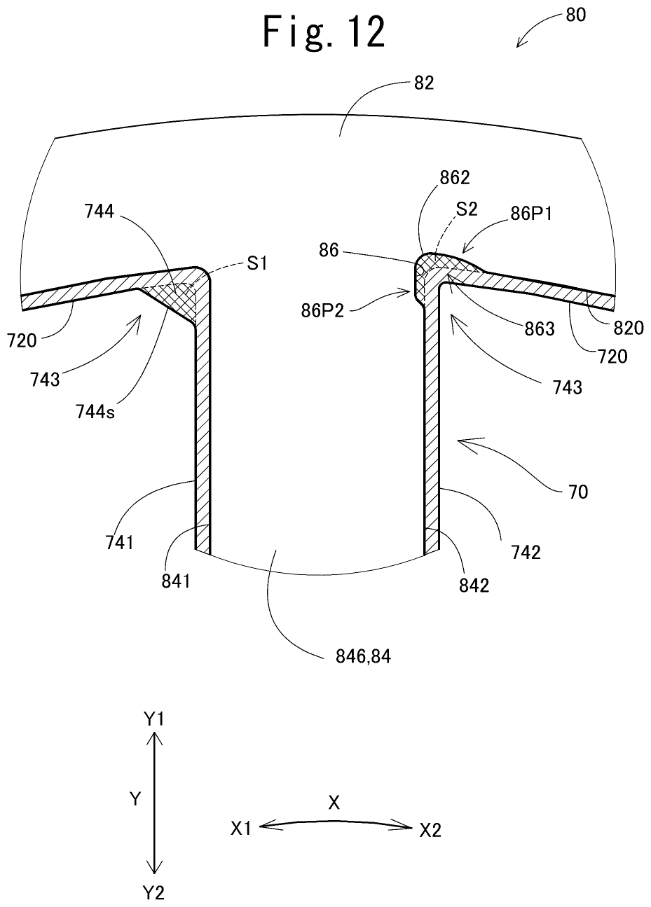

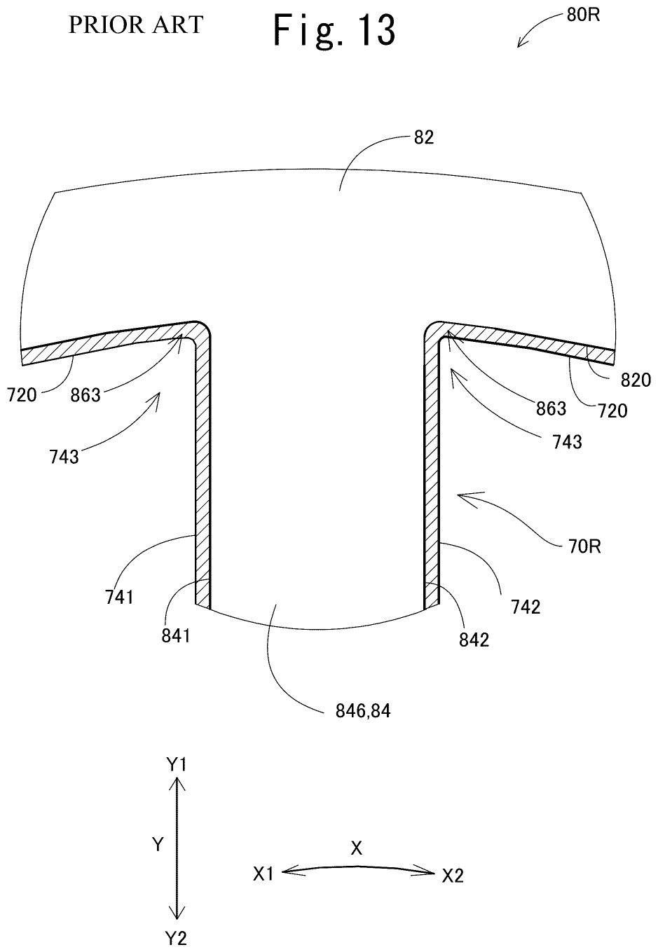

The configuration (shape) of the stator core 80 is now described with reference to FIGS. 12 and 13. FIG. 12 is an explanatory view showing the circular area AR1 shown in FIG. 3 in an enlarged manner. In the present embodiment, as shown in FIG. 12, the stator core 80 includes a cutout 86 having a recessed shape that recesses from a direction toward the slot 78 toward the opposite side. The cutout 86 is formed at a connection part 863 that connects the tooth second side surface 842 and the inner peripheral surface 820 of the yoke 82.

FIG. 13 is an explanatory view showing the configuration of a known stator core 80R as a comparative example. As shown in FIG. 13, a known electrical insulation body 70R does not have the projection 744 and the stator core 80R does not include the cutout 86. In the known stator core 80R of FIG. 13, the cross-sectional area of the connection part 743 on the side of the first side surface 741 and the cross-sectional area of the connection part 743 on the side of the second side surface 742 are the same or at least substantially the same. Thus, when forming the electrical insulation body 70R using the stator core 80R, the flow rate of the resin material at the connection part 743 on the side of the first side surface 741 and the flow rate of the resin material at the connection part 743 on the side of the second side surface 742 are at least substantially the same. Thus, when forming the electrical insulation body 70, e.g., by insert molding, in which the resin material is introduced between the stator core 80 and the mold, the resin material reliably flows so as to be substantially uniform both on the side of the first side surface 741 and on the side of the second side surface 742.

In contrast to this, in the present embodiment as shown in FIG. 12, the electrical insulation body 70 includes the projection 744 that is formed at the connection part 743 on the side of the first side surface 741. The surface area S1 shown by cross hatching in FIG. 12 is the cross-sectional area of the projection 744 in a plane perpendicular to the axial direction Z. The surface area S1 can be thought of as an increase in surface area as compared to the known electrical insulation body 70R, due to the formation of the projection 744.

For example, in an embodiment in which only the projection 744 is formed without forming the cutout 86 shown in FIG. 12, the volume of the space between the mold and the stator core 80 increases by an amount corresponding (proportional) to the surface area S1. Thus, when forming the electrical insulation body 70 by insert molding, the resin flows easily into the position of the projection 744. As a result, the flow rate of the resin material on the side of the first side surface 741 can become larger than the flow rate of the resin material on the side of the second side surface 742. In this case, there is a possibility that the resin material might not sufficiently fill between the mold and the connection part 743 on the side of the second side surface 742, whereby a molding defect may occur, such as a so-called “short shot”.

In the present embodiment, the cutout 86 is formed in (on) the tooth second side surface 842 on the opposite side from the tooth first side surface 841 at which the projection 744 is formed. The cutout 86 increases the volume between the stator core 80 and the mold, thereby increasing the flow rate of the resin material introduced during the insert molding. In the present embodiment, by forming the cutout 86 on the side of the second side surface 742, the flow rate of the resin material at the connection part 743 on the side of the first side surface 741 and the flow rate of the resin material at the connection part 743 on the side of the second side surface 742 become the same or at least substantially uniform (the same).

As shown in FIG. 12, the cutout 86 is formed in the yoke inner peripheral surface 820 of the yoke 82, and includes a first portion 86P1 having a recessed shape that is recessed from the yoke inner peripheral surface 820 toward the outer side Y1 in the radial direction, and a second portion 86P2 having a recessed shape that is recessed from the tooth second side surface 842 toward the first side X1 in the circumferential direction. As a result of including both the first portion 86P1 and the second portion 86P2, the surface area of the cutout 86 is increased, and it is possible to increase the flow rate of the resin material in the cutout 86. Further, in the present embodiment, the first portion 86P1 and the second portion 86P2 have recessed shapes that are integrally (fluidly) connected to each other. By forming the cutout 86 over a relatively wide range from the yoke inner peripheral surface 820 to the tooth second side surface 842, it is possible to increase the flow rate of the resin material at the connection part 863 to a greater extent than in an embodiment in which two separate (discrete) cutouts were to be provided separately (discretely) in the yoke inner peripheral surface 820 and in the tooth second side surface 842, respectively.

As shown in FIG. 12, the contour of the cutout 86 in the cross-sectional shape perpendicular to the axial direction Z includes curved lines. For example, the first portion 86P1 and the second portion 86P2 are connected by a curved part 862 having a relatively small radius of curvature. The radius of curvature of the curved part 862 is, for example, smaller than the radius of curvature of the connection part 863 between the yoke inner peripheral surface 820 and the tooth first side surface 841 shown on the left side in FIG. 12. By utilizing this kind of configuration, the flow path resistance of the cutout 86 is reduced, and the flow rate of the resin material in the cutout 86 during insert molding can be increased. Thus, it is possible to downsize the cutout 86 as compared to an embodiment in which the curved part 862 is not provided.

Note that, in the present embodiment, the cross-sectional surface area S1 of the projection 744 and a cross-sectional surface area S2 of the cutout 86 are preferably configured (set) to be different from each other. Specifically, the cross-sectional surface area S2 is configured to be smaller than the cross-sectional surface area S1. This is done in order to take into account a difference in the flow rates of the resin material on the side of the first side surface 741 and on the side of the second side surface 742 resulting from the thickness T2 of the second flange 762 being thicker than the thickness T1 of the first flange 761.

As described above, according to the motor 310 of the present embodiment, the electrical insulation body 70 includes the projection 744, which is connected to the inner peripheral surface 720 of the outer wall part 72 and to the first side surface 741, at the connection part 743 between the drum part 74 and the outer wall part 72. When winding the stator winding 90 on the first side surface 741, the lead wire of the stator winding 90 can be guided along the projection 744 to the correct arrangement position. Moreover, the projection 744 can restrict (block) movement (displacement) of the stator winding 90 toward the outer side Y1 in the radial direction. Thus, it is thus possible to reduce the likelihood of or even prevent the rows of the stator winding 90 on the first side surface 741 from becoming misaligned, whereby the space factor of the stator winding 90 can be improved.

According to the motor 310 of the present embodiment, the angle θ1 between the surface direction of the inclined wall surface 744s and the extending direction of the drum part 74 is configured (set) to be approximately 55 degrees. By utilizing this kind of configuration, it is possible to closely array the rows of the stator winding 90 in a close packed structure, whereby the space factor of the stator winding 90 can be improved.

According to the motor 310 of the present embodiment, the cross-sectional width WS from the inner peripheral surface 720 to the first side surface 741 at the projection 744 is configured (set) to be approximately 2.2 times the diameter DM of the lead wire that forms the stator winding 90. By utilizing this kind of configuration, in the three stages from the first stage ST1 to the third stage ST3, the rows of the stator winding 90 on the outermost side in the radial direction Y can be closely arrayed so as to be a close packed structure. Thus, it is possible to improve the space factor of the stator winding 90 over (across) the plurality of stages (layers) of the lead wire.

According to the motor 310 of the present embodiment, the thickness T2 of the second flange 762 in the radial direction Y is configured (set) to be thicker than the thickness T1 of the first flange 761 in the radial direction Y. Thus, on the second side surface 742, it is possible to reduce the likelihood of or even prevent the occurrence of a gap SP between rows of the stator winding 90, whereby the space factor of the stator winding 90 can be improved.

According to the motor 310 of the present embodiment, the position of the portion the stator winding 90A that (directly) contacts the second flange 762 on the second side surface 742 is offset by the angle θ2 toward the outer side Y1 in the radial direction relative to the position of the portion of the stator winding 90B that (directly) contacts the first flange 761 on the first side surface 741. By winding the stator winding 90 so that the rows are inclined toward the outer side Y1 in the radial direction by the angle θ2 with respect to a parallel arrangement, it is possible to perform the winding while applying a force in the direction toward the outer side Y1 in the radial direction. Thus, it is possible to wind the subsequent stator winding 90 while causing the stator winding 90 to be adjacent to the already wound stator winding 90 on the outer side Y1 in the radial direction, and it is thus possible to reduce the likelihood of or even prevent the array of rows of the stator winding 90 from becoming misaligned.

According to the motor 310 of the present embodiment, on the inner peripheral surface 720, the groove 724 that extends in the axial direction is provided at a position intersecting the surface direction SD of the second side surface 742. Thus, it is possible to reduce the likelihood of or even prevent interference between the portion 90S of the stator winding 90 that is guided from the outer wall part 72 to the second side surface 742 and the portion(s) 90T of the stator winding 90 that form(s) the second stage ST2 or the following stages.

According to the motor 310 of the present embodiment, the first electrical insulation part 701, the second electrical insulation part 702, and the insulation body connection part 703 of the electrical insulation body 70 are integrally formed by the insert molding such that there is no seam between these structures. Thus, it is possible to reduce the number of steps for assembling the electrical insulation body 70 and the stator core 80, whereby manufacturing productivity of the motor 310 can be improved.

According to the motor 310 of the present embodiment, the stator core 80 includes the recess shaped cutout 86 formed in the tooth second side surface 842, and in the portion of the yoke inner peripheral surface 820 of the yoke 82 that is adjacent to the tooth second side surface 842. Thus, when forming the electrical insulation body 70 by insert molding, it is possible to increase the flow rate of the resin material at the connection part 743 on the side of the second side surface 742. As a result, for example, even when the flow rate of the resin material at the connection part 743 on the side of the first side surface 741 is increased owing to the presence of the projection 744, the flow rate balance of the resin material on the first side surface 741 and on the second side surface 742 can be favorably set. Thus, when forming the electrical insulation body 70, it is possible to reduce or prevent molding defects, such as “short shots” and the like.

According to the motor 310 of the present embodiment, at the connection part 863 at which the tooth base part 846 and the yoke 82 are connected, the cutout 86 has an integrated (combined) recessed shape that includes the first portion 86P1 formed on (in) the yoke inner peripheral surface 820 of the yoke 82 and the second portion 86P2 formed on (in) the tooth second side surface 842. By forming the cutout 86 over a relatively wide range from the yoke inner peripheral surface 820 to the tooth second side surface 842, the flow rate of the resin material at the cutout 86 during insert molding can be increased, compared to an embodiment in which cutouts are separately provided in the yoke inner peripheral surface 820 and in the tooth second side surface 842, respectively.

According to the motor 310 of the present embodiment, the cutout 86 includes the curved part 862 having a smaller radius of curvature than the radius of curvature of the connection part 863 between the yoke inner peripheral surface 820 of the yoke 82 and the tooth first side surface 841. Thus, the flow path resistance of the cutout 86 is reduced, and the flow rate of the resin material at the cutout 86 during insert molding can be increased.

According to the motor 310 of the present embodiment, the cross-sectional surface area S1 of the projection 744 and the cross-sectional surface area S2 of the cutout 86 are configured (set) to be different from each other. Even if the flow rate of the resin material differs at positions other than the connection part 863, the flow rate balance of the resin material during insert molding can be favorably set, e.g., due to the thicknesses of the second flange 762 and the first flange 761 being different from each other.

### B. Second Embodiment

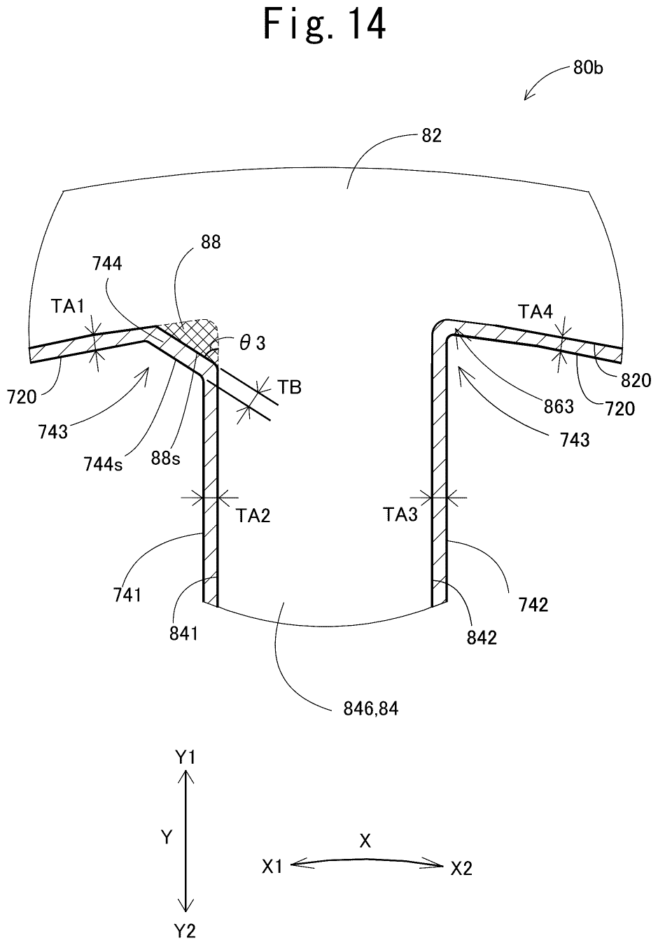

FIG. 14 is an explanatory view showing the configuration of a portion of a stator core 80b according to a second embodiment. This stator core 80b differs from the stator core 80 shown in the first embodiment in that the stator core 80b has a tooth projection 88 in place of the cutout 86; the rest of the configuration is the same. When the electrical insulation body 70 that includes the projection 744 is formed by insert molding, the tooth projection 88 reduces the likelihood of or even prevents an increase in the flow rate of the resin material flowing to the connection part 743 on the first side surface 741.

The tooth projection 88 is connected to the yoke inner peripheral surface 820 of the yoke 82 and to the tooth first side surface 841, at the connection part 863 between the tooth base part 846 and the yoke 82. The tooth projection 88 has a shape that protrudes toward the slot 78. In the present embodiment, the shape of the tooth projection 88 is substantially the same as the cross-sectional shape of the projection 744 shown in the above-described first embodiment. Specifically, the tooth projection 88 is configured to protrude from the yoke inner peripheral surface 820 toward the inner side Y2 in the radial direction, and to protrude from the tooth first side surface 841 toward the first side X1 in the circumferential direction. The tooth projection 88 includes a tooth inclined wall surface 88s connected to the yoke inner peripheral surface 820 and to the tooth first side surface 841. The inclination angle θ3 formed between a surface direction of the tooth inclined wall surface 88s of the tooth projection 88 and the radial direction Y is configured (set) to be the same as the above-described inclination angle θ1, e.g., approximately 55 degrees, although it may be in the range of 40-70 degrees. By forming the tooth projection 88 in this manner, it is possible to reduce the likelihood of an increase of the volume between the connection part 863 and the mold. Thus, when the projection 744 is formed, it is possible to reduce the likelihood of or even prevent an increase in the flow rate of the resin material on the side of the first side surface 741.

In the present embodiment, distance TA1 from the yoke inner peripheral surface 820 on the side of the tooth first side surface 841 to the mold, distance TA2 from the tooth first side surface 841 to the mold, distance TA4 from the yoke inner peripheral surface 820 on the side of the tooth second side surface 842 to the mold, and distance TA3 from the tooth second side surface 842 to the mold, etc. are all set to be the same as distance TB from the tooth inclined wall surface 88s to the mold. “The same as distance TB” includes an error or tolerance of ±10% with respect to the distance TB. In this way, for example, it is possible to make the overall flow rate of the resin material uniform during insert molding. Thus, while forming the projection 744 by insert molding, it is possible to reduce the likelihood of or even prevent local variations in the flow rate of the resin material. Furthermore, since the thickness of the electrical insulation body 70 is preferably at least substantially uniform, it is possible to reduce the likelihood of or even prevent local variations in the electrical insulating properties of the stator core 80.

### C. Third Embodiment

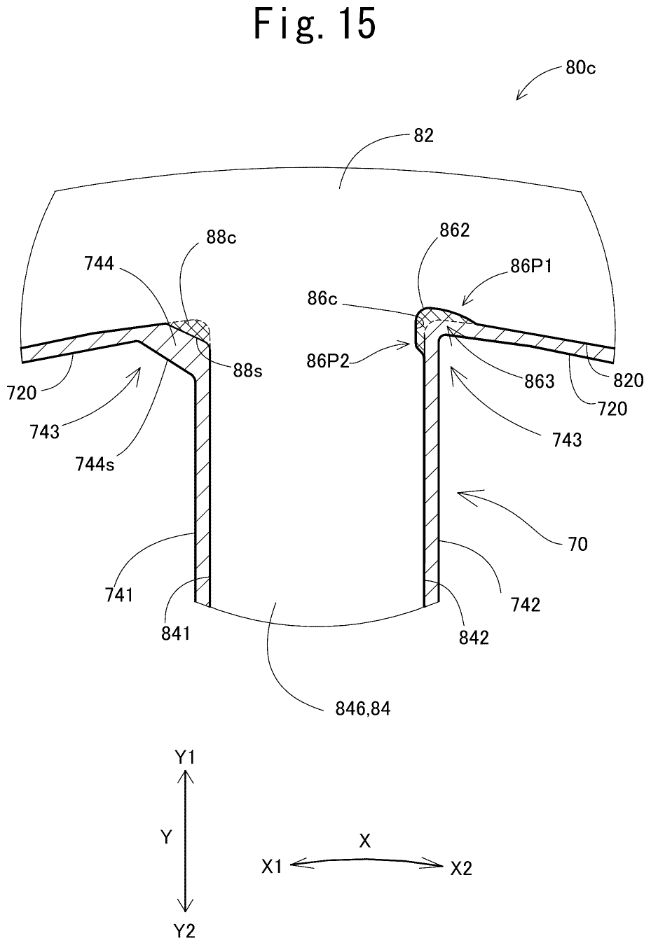

FIG. 15 is an explanatory view showing the configuration of a stator core 80c 0 according to a third embodiment. As shown in FIG. 15, the stator core 80c includes a cutout 86c that is downsized in comparison to the cutout 86 shown in the above-described first embodiment, and a tooth projection 88c that is downsized in comparison to the tooth projection 88 shown in the above-described second embodiment. In this way, the stator core 80c is provided with both the cutout 86c and the tooth projection 88c. Even with this kind of configuration, when forming the electrical insulation body 70 that includes the projection 744 by insert molding, the flow rate balance of the resin material on the first side surface 741 and on the second side surface 742 during insert molding can be favorably set.

### D. Fourth Embodiment

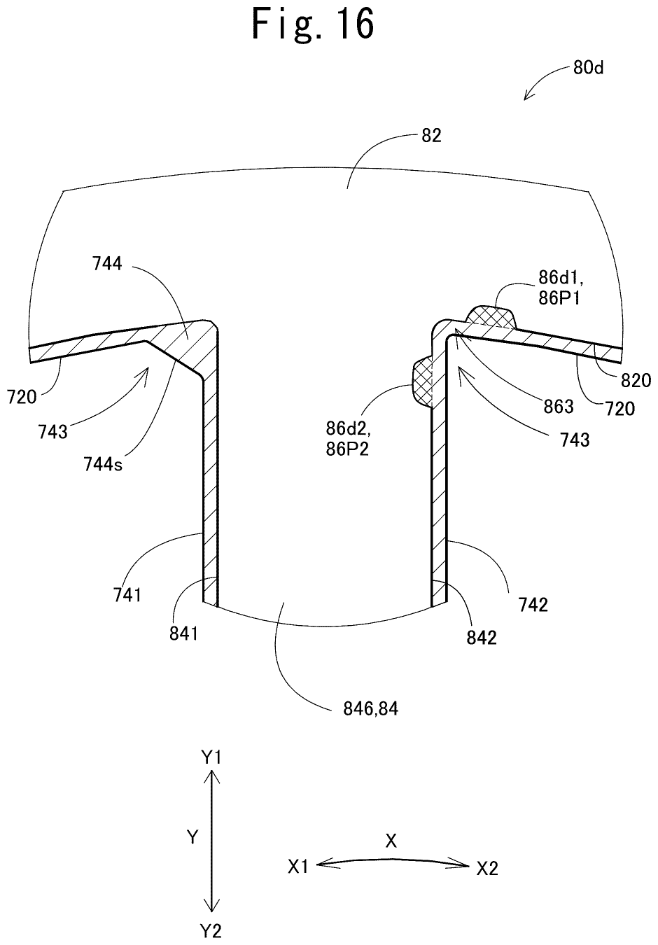

FIG. 16 is an explanatory view of a stator core 80d according to a fourth embodiment. As shown in FIG. 16, the stator core 80d includes a plurality of projections 86d1 and 86d2. More specifically, the stator core 80d differs from the stator core 80 shown in the above-described first embodiment in that the stator core 80d does not have the curved part 862, and differs in being configured such that a first portion 86P1 formed on (in) the yoke inner peripheral surface 820 of the yoke 82, and a second portion 86P2 formed on (in) the tooth second side surface 842 are separately provided. As a result, the first portion 86P1 functions as a cutout 86d1, and the second portion 86P2 functions as a cutout 86d2. Even with this kind of configuration, when forming the electrical insulation body 70 that includes the projection 744 by insert molding, the flow rate balance of the resin material at the first side surface 741 and the second side surface 742 during insert molding can be favorably set.

The present disclosure is not limited to the structures described in the above embodiments, and embodiments of the present teachings can be realized according to various configurations insofar as they do not depart from the gist and scope of the present disclosure. For example, technological features in the embodiments corresponding to technological features in each of aspects listed in the summary above can be switched, or combined as appropriate, in order to provide additional embodiments of the present teachings, and/or in order to achieve one, some or all of the above-described effects. Further, insofar as those technological features are not described as being essential in the present disclosure, they can be omitted as appropriate.

### DESCRIPTION OF THE REFERENCE NUMERALS

70, 70R: electrical insulation body
72: outer wall part
74: drum part
76: inner wall part
78: slot
80, 80R, 80b, 80c, 80d: stator core
82: yoke
84: tooth
86, 86c, 86d1, 86d2: projection
86P1: first portion
86P2: second portion
88, 88c: tooth projection
88s: tooth inclined wall surface
90, 90A, 90B, 90S, 90T: stator winding
100: stator
200: rotor
300: compressor
301: housing
302: intake port
303: motor chamber
304: fluid communication path
305: discharge port
310: motor
320: compression mechanism
322: fixed scroll
324: movable scroll
330: drive shaft
332: eccentric pin
340: drive circuit
701: first electrical insulation part
702: second electrical insulation part
703: insulation body connection part
720: inner peripheral surface
722T: top end
724: groove
741: first side surface
742: second side surface
743: connection part
744: projection
744s: inclined wall surface
746: first end surface
746E: protrusion
746R: recess
761: first flange
762: second flange
780: slot opening
820: yoke inner peripheral surface
841: tooth first side surface
842: tooth second side surface
844: tooth tip part
844T: tooth tip end surface
846: tooth base part
862: curved part
863: connection part
AX: rotational axis
SP: gap

What is claimed is:

1. A motor, comprising:
a rotor and a stator,
wherein:
the stator includes a stator core, an electrical insulation body, and stator windings,
the stator core has a cylindrical shape extending in an axial direction, and includes:
a yoke extending in a circumferential direction; and
teeth extending radially inward from the yoke;
each of the teeth has:
a tooth base part extending radially inward from the yoke; and
a tooth tip part that is continuous with a radially inward tip end of the tooth base part;
the tooth base part has a tooth first side surface on a first side in the circumferential direction and a tooth second side surface on a second side in the circumferential direction,
the electrical insulation body includes:
a first outer wall part on a first side in the axial direction of the yoke;
a first drum part on the first side in the axial direction of the tooth base part; and
a first inner wall part on the first side in the axial direction of the tooth tip part; and
the first drum part includes a first side surface on the first side in the circumferential direction and a second side surface on the second side in the circumferential direction,
each of the stator windings is wound around the respective tooth base part with at least the first drum part being arranged on the first side in the axial direction of the tooth base part,
the electrical insulation body includes a projection formed at a connection part between the first drum part and the first outer wall part, the projection having an inclined wall surface that connects an inner peripheral surface of the first outer wall part to the first side surface, and
the stator core includes at least one of:
a cutout formed in at least one of the tooth second side surface and a yoke inner peripheral surface, the cutout having a recessed shape that is recessed toward an opposite side from a slot defined by circumferentially adjacent ones of the teeth; and
a tooth projection formed at a connection part between the tooth first side surface and the yoke inner peripheral surface, and protruding toward the slot.

2. The motor as defined in claim 1, wherein:
the cutout is formed in the stator core,
the cutout is provided at a connection part between the tooth second side surface and the yoke inner peripheral surface, and
the cutout has the recessed shape that include a first portion formed on the yoke inner peripheral surface and a second portion formed on the tooth second side surface.

3. The motor as defined in claim 2, wherein:
the cutout has a curved portion having a smaller radius of curvature than a radius of curvature of the connection part between the yoke inner peripheral surface and the tooth first side surface.

4. The motor as defined in claim 2, wherein:
the projection has a first cross-sectional surface area,
the cutout has a second cross-sectional surface area, and
the first cross-sectional surface area is not equal to the second cross-sectional area.

5. The motor as defined in claim 1, wherein:
the tooth projection is formed on the stator core, and
a first thickness of the electrical insulation body is defined from a surface of the tooth projection to a surface of the projection provided on the electrical insulation body,
a second thickness of the electrical insulation body is defined from the tooth first side surface to a surface of the first drum part of the electrical insulation body, and
the first thickness equals the second thickness.

6. The motor as defined in claim 1, wherein:
the electrical insulation body further includes:
a second outer wall part on a second side in the axial direction of the yoke;
a second drum part on the second side in the axial direction of the tooth base part; and
a second inner wall part on the second side in the axial direction of the tooth tip part,
wherein:
a first electrical insulation part includes the first outer wall part, the first drum part, and the first inner wall part;
a second electrical insulation part includes the second outer wall part, the second drum part, and the second inner wall part, and
an insulation body connection part extends continuously between the first electrical insulation part and the second electrical insulation part in an integral manner with no seam therebetween.

7. A compressor, comprising:
a compression mechanism configured to compress a refrigerant, and
the motor according to claim 1 configured to drive the compression mechanism.
